(19) United States
(12) Patent Application Publication
(10) Pub. No.: US 2024/0356066 A1
(43) Pub. Date: Oct. 24, 2024

(54) ALL SOLID BATTERY

(71) Applicant: TAIYO YUDEN CO., LTD., Tokyo (JP)

(72) Inventors: Katsunori YOKOSHIMA, Tokyo (JP); Masashi SEKIGUCHI, Tokyo (JP); Daigo ITO, Tokyo (JP)

(73) Assignee: TAIYO YUDEN CO., LTD., Tokyo (JP)

(21) Appl. No.: 18/685,126

(22) PCT Filed: Jul. 28, 2022
(86) PCT No.: PCT/JP2022/029121

§ 371 Date: Feb. 20, 2024

(30) Foreign Application Priority Data
Sep. 13, 2021 (JP) 2021-148320

(51) Int. Cl. H01M 10/0562; H01M 4/02; H01M 4/136; H01M 4/58; H01M 4/62; H01M 10/0585; H01M 10/42

(52) U.S. Cl. CPC H01M 10/0562; H01M 4/136; H01M 4/5825; H01M 4/62; H01M 10/0585; H01M 10/4235; H01M 2004/027; H01M 2004/028; H01M 2300/0068

(57) ABSTRACT

An all solid battery includes a solid electrolyte layer of a phosphate-based material having a NASICON structure, a positive electrode layer that includes a Co-containing phosphate-based positive electrode active material and a Co-containing phosphate-based solid electrolyte, and a negative electrode layer that includes a negative electrode active material and a solid electrolyte not containing Co.

### TECHNICAL FIELD

The present invention relates to an all solid battery.

### BACKGROUND ART

In recent years, lithium ion secondary batteries have been widely used as electrical power sources for portable electronic devices, wearable devices, IoT devices or the like due to their high energy density. In these lithium ion secondary batteries, an electrolytic liquid solution using a flammable organic solvent is used as a medium for moving ions. In batteries using such a flammable electrolyte, risks such as leakage of the electrolyte, smoke, and ignition have been pointed out as problems. As a means to eliminate these risks and ensure essential safety, a flame-retardant solid electrolyte is used as an alternative to flammable organic electrolytes, and all solid batteries in which all components are solid are being developed. Among all solid batteries that use oxide-based solid electrolytes that are highly stable in the atmosphere, various components including the solid electrolyte are co-fired at high temperatures in order to reduce grain boundary resistance between solid electrolyte particles.

For example, as a means to suppress element diffusion during co-firing, a method has been disclosed in which the same transition metal element as the transition metal contained in the active material is added to the solid electrolyte in advance (see, for example, Patent Document 1).

### PRIOR ART DOCUMENT

### Patent Document

Patent Document 1: Japanese Patent Application Publication No. 2015-11864

### DISCLOSURE OF THE INVENTION

### Problems to be Solved by the Invention

This method can suppress the elemental diffusion of transition metal elements contained in the electrode active material and improve the active material survival rate during co-firing, which is effective in improving battery capacity, but initial charge/discharge efficiency or cycle characteristics is not referred to.

The present invention was made in view of the above problems, and an object thereof is to provide an all solid battery that can improve initial charge/discharge efficiency and cycle characteristics.

### Means for Solving the Problems

An all solid battery of the present invention is characterized by including: a solid electrolyte layer of a phosphate-based material having a NASICON structure; a positive electrode layer that includes a Co-containing phosphate-based positive electrode active material and a Co-containing phosphate-based solid electrolyte; and a negative electrode layer that includes a negative electrode active material and a solid electrolyte not containing Co.

The above-mentioned all solid battery may operate at an operating voltage of 2.5 V or more.

In the above-mentioned all solid battery, the positive electrode active material may operate at an average operating voltage of 4.5V vs. Li/Li⁺ or more, and the negative electrode active material may operate at an average operating voltage of 2.0 V vs. Li/Li⁺ or less.

In the above-mentioned all solid battery, the Co-containing phosphate-based solid electrolyte of the positive electrode layer may include a glass ceramics in which a Co-containing solid electrolyte glass is crystallized.

In the above-mentioned all solid battery, a molar ratio of Co/P may be 16.8 mol % or less in the Co-containing phosphate-based solid electrolyte of the positive electrode layer.

In the above-mentioned all solid battery, an average grain diameter of the Co-containing phosphate-based solid electrolyte of the positive electrode layer and an average grain diameter of the solid electrolyte not containing Co of the negative electrode layer may be 0.1 μm or more and 10 μm or less.

In the above-mentioned all solid battery, a volume ratio of the Co-containing phosphate-based solid electrolyte of the positive electrode layer and a volume ratio of the solid electrolyte not containing Co of the negative electrode layer may be 20 vol. % or more and 75 vol. % or less.

### Effects of the Invention

According to the present invention, it is possible to provide an all solid battery that can improve initial charge/discharge efficiency and cycle characteristics.

### BRIEF DESCRIPTION OF THE DRAWINGS

FIG. 1 is a schematic cross-sectional view illustrating a basic structure of an all solid battery;

FIG. 2 illustrates a schematic cross section of an all solid battery of an embodiment;

FIG. 3 illustrates a schematic cross section of another all solid battery,

FIG. 4 illustrates a flowchart of a manufacturing method of an all solid battery;

FIG. 5A and FIG. 5B illustrate a stacking process;

FIG. 6 illustrates a diagram showing a charge/discharge curve of Example 4;

FIG. 7 illustrates a diagram showing a charge/discharge curve of Comparative Example 1; and

FIG. 8 is a diagram showing cycle characteristics for Examples 1 to 7 and Comparative Examples 1 and 2.

### BEST MODES FOR CARRYING OUT THE INVENTION

A description will be given of an embodiment with reference to the accompanying drawings.

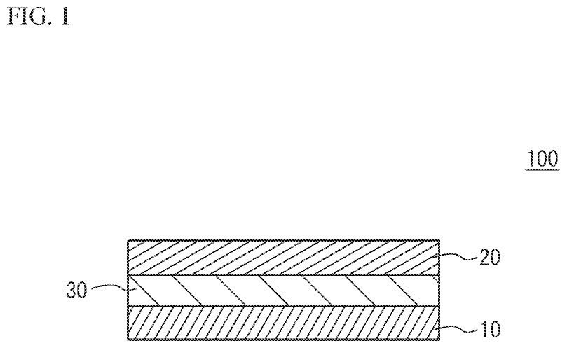

(Embodiment) FIG. 1 is a schematic cross-sectional view illustrating the basic structure of an all solid battery 100. As illustrated in FIG. 1, the all solid battery 100 has a structure in which a solid electrolyte layer 30 is sandwiched between a first internal electrode 10 and a second internal electrode 20. The first internal electrode 10 is formed on a first main face of the solid electrolyte layer 30. The second internal electrode 20 is formed on a second main face of the solid electrolyte layer 30.

When the all solid battery 100 is used as a secondary battery, one of the first internal electrode 10 and the second internal electrode 20 is used as a positive electrode, and the other is used as a negative electrode. In this embodiment, as an example, the first internal electrode 10 is used as a positive electrode, and the second internal electrode 20 is used as a negative electrode.

The solid electrolyte layer 30 has a solid electrolyte having ionic conductivity as a main component. The solid electrolyte of the solid electrolyte layer 30 is, for example, an oxide-based solid electrolyte having lithium ion conductivity. The solid electrolyte is, for example, a phosphate solid electrolyte having a NASICON structure. The phosphoric acid salt-based solid electrolyte having the NASICON structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄) ₃ or the like. For example, in this embodiment, a Li—Al—Ge—PO₄-based material to which Co has been added in advance is used in the same manner as the Co-containing phosphate-based solid electrolyte contained in the first internal electrode 10, which is the positive electrode may be used as the phosphate-based solid electrolyte. The phosphate solid electrolyte may not necessarily contain Co.

When the phosphate-based solid electrolyte contains Co, it is preferable to design the solid electrolyte layer 30 so that the Co concentration is higher on the positive electrode side than on the negative electrode side, and the Co concentration on the negative electrode side is low or Co is not present near the negative electrode. In this case, it is possible to achieve the effect that the oxidation resistance near the positive electrode is improved and the reduction resistance near the negative electrode is also achieved.

The first internal electrode 10 used as a positive electrode layer includes a Co-containing phosphate-based positive electrode active material. For example, It is preferable to use a Co-containing phosphate-based positive electrode active material that operates at an average potential of 4.5V vs. Li/Li⁺ or higher, as the positive electrode active material of the first internal electrode 10. For example, the positive electrode active material is such as LiCoPO₄, Li₂CoP₂O₇, Li₆Co₅(P₂O₇)₄, or the like.

The second internal electrode 20 used as a negative electrode layer contains a negative electrode active material. For example, it is preferable to use a negative electrode active material that operates at an average potential of 2V vs. Li/Li⁺ or less, as the negative electrode active material of the second internal electrode 20. For example, the negative electrode active material is such as TiO₂, Nb₂O₅, Ti—Nb—O based compounds, or the like. Such a negative electrode active material can increase the operating voltage of the all solid battery 100 to 2.5 V or higher when combined with a positive electrode active material having an operating potential of 4.5V vs. Li/Li⁺ or higher.

In the forming process of the first internal electrode 10 and the second internal electrode 20, moreover, oxide-based solid electrolyte material having ion conductivity or a conductive material (conductive auxiliary agent) is added. When the material is evenly dispersed into water or organic solution together with binder or plasticizer, paste for electrode layer is obtained. A carbon material may be used as the conductive auxiliary agent. A metal material may be used as the auxiliary agent. Pd, Ni, Cu, or Fe, or an alloy thereof may be used as the metal material of the conductive auxiliary agent.

Unlike lithium ion secondary batteries that use conventional electrolytes, the all solid battery 100 allows the use of suitable electrolytes for each of the positive and negative electrodes. Therefore, in this embodiment, materials with different compositions are used as the solid electrolyte included in the first internal electrode 10 and the solid electrolyte included in the second internal electrode 20.

In this embodiment, a Co-containing phosphate-based solid electrolyte is used as the solid electrolyte included in the first internal electrode 10. By introducing an appropriate amount of Co into the phosphate solid electrolyte, the oxidation resistance of the positive electrode can be improved. As the Co-containing phosphate solid electrolyte, it is preferable to use a Co-added Li—Al—Ge—PO₄ material or the like. Alternatively, it is preferable to use glass ceramics obtained by crystallizing Co-containing solid electrolyte glass as the Co-containing phosphate-based solid electrolyte.

On the other hand, the solid electrolyte included in the second internal electrode 20 is a solid electrolyte that does not contain Co. Thereby, reduction resistance on the negative electrode side can be improved. When the main component solid electrolyte of the solid electrolyte layer 30 does not contain Co, the main component solid electrolyte may be used as the solid electrolyte included in the second internal electrode 20. Here, “not containing Co” can be defined as being 1/100 or less of the Co content of the first internal electrode 10, or below the detection limit in SEM-EDS.

As described above, by using a Co-containing phosphate solid electrolyte as the solid electrolyte included in the first internal electrode 10 and using a Co-free solid electrolyte as the solid electrolyte included in the second internal electrode 20, the oxidation resistance on the positive electrode side can be improved, and the reduction resistance on the negative electrode side can be improved. Thereby, initial charge/discharge efficiency and cycle characteristics can be improved. Note that when the operating voltage of the all solid battery 100 is high, oxidation resistance on the positive electrode side and reduction resistance on the negative electrode side are particularly required. This effect becomes noticeable when the operating voltage of the all solid battery 100 is high (for example, when the operating voltage is 2.5 V or higher).

Note that in the Co-containing phosphate solid electrolyte included in the first internal electrode 10, if the amount of Co is too large, a Co-containing compound with low electronic conductivity is generated during co-firing, resulting in increase in internal resistance (ESR). Therefore, in the Co-containing phosphate solid electrolyte included in the first internal electrode 10, it is preferable to set an upper limit on the amount of Co. For example, in the Co-containing phosphate solid electrolyte included in the first internal electrode 10, the Co/P molar ratio is preferably 16.8 mol % or less, more preferably 13.5 mol % or less, and even more preferably 10.2 mol % or less.

On the other hand, if the amount of Co in the Co-containing phosphate solid electrolyte contained in the first internal electrode 10 is too small, the oxidation resistance may become insufficient. Therefore, in the Co-containing phosphate solid electrolyte included in the first internal electrode 10, it is preferable to set a lower limit to the amount of Co. For example, in the Co-containing phosphate solid electrolyte included in the first internal electrode 10, the Co/P molar ratio is preferably 1.7 mol % or more, more preferably 3.3 mol % or more, even more preferably 6.7 mol % or more.

In the first internal electrode 10 and the second internal electrode 20, if the average grain diameter of the solid electrolyte is too large, there is a risk that high temperature will be required for sintering and densification. Therefore, it is preferable to set an upper limit on the average grain diameter of the solid electrolyte in the first internal electrode 10 and the second internal electrode 20. On the other hand, if the average grain diameter of the solid electrolyte in the first internal electrode 10 and the second internal electrode 20 is too small, the dispersion state of the electrode paste becomes unstable, making it difficult to obtain a dense coating film.

Furthermore, there is a risk that the reactivity of the all solid battery 100 during heat treatment may increase, making interdiffusion reactions more likely to occur. Therefore, it is preferable to set a lower limit to the average grain diameter of the solid electrolyte in the first internal electrode 10 and the second internal electrode 20. For example, the average grain diameter of the solid electrolyte in the first internal electrode 10 and the second internal electrode 20 is preferably 0.1 μm or more and 10 μm or less, more preferably 0.5 μm or more and 7 μm or less, and even more preferably 1 μm or more and 5 μm or less.

Furthermore, if the volume ratio occupied by the solid electrolyte in each of the first internal electrode 10 and the second internal electrode 20 is too high, there is a risk that the filling amount of the electrode active material cannot be increased, and the capacity may decrease. Therefore, it is preferable to set an upper limit on the volume ratio occupied by the solid electrolyte in each of the first internal electrode 10 and the second internal electrode 20. On the other hand, if the volume ratio occupied by the solid electrolyte in each of the first internal electrode 10 and the second internal electrode 20 is too low, there is a risk that an ionic conduction path may not be secured and internal resistance may increase. Therefore, it is preferable to set a lower limit to the volume ratio occupied by the solid electrolyte in each of the first internal electrode 10 and the second internal electrode 20. For example, in each of the first internal electrode 10 and the second internal electrode 20, the volume ratio occupied by the solid electrolyte is preferably 20 to 75 vol. %, more preferably 25 to 70 vol. %, and even more preferably 30 to 65 vol. %.

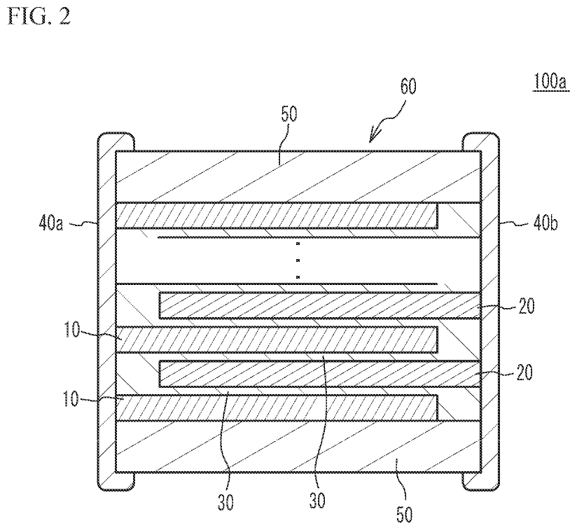

FIG. 2 illustrates a schematic cross section of an all solid battery 100a in which a plurality of cell units are stacked. The all solid battery 100a has a multilayer chip 60 having a rectangular parallelepiped shape. Each of a first external electrode 40a and a second external electrode 40b is provided directly on each of two side faces among four side faces which are other than an upper face and a lower face of the multilayer chip 60 in the stacking direction. The two side faces may be adjacent to each other. Alternatively, the two side faces may be face with each other. In the embodiment, the first external electrode 40a and the second external electrode 40b are provided so as to contact two side faces facing each other (hereinafter referred to as two edge faces).

In the following description, the same numeral is added to each member that has the same composition range, the same thickness range and the same particle distribution range as that of the all solid battery 100. And, a detail explanation of the same member is omitted.

In the all solid battery 100a, each of the first internal electrodes 10 and each of the second internal electrodes 20 sandwich each of the solid electrolyte layer 30 and are alternately stacked. Edges of the first internal electrodes 10 are exposed to the first edge face of the multilayer chip 60 but are not exposed to the second edge face of the multilayer chip 60. Edges of the second internal electrodes 20 are exposed to the second edge face of the multilayer chip 60 but are not exposed to the first edge face. Thus, each of the first internal electrodes 10 and each of the second internal electrodes 20 are alternately conducted to the first external electrode 40a and the second external electrode 40b. The solid electrolyte layer 30 extends from the first external electrode 40a to the second external electrode 40b. In this way, the all solid battery 100a has a structure in which a plurality of cell units are stacked.

A cover layer 50 is stacked on an upper face (in FIG. 2 on the upper face of the uppermost internal electrode) of a stacked structure of the first internal electrode 10, the solid electrolyte layer 30 and the second internal electrode 20. Another cover layer 50 is stacked on a lower face (in FIG. 2, on the lower face of the lowermost internal electrode) of the stacked structure. A main component of the cover layer 50 is an inorganic material such as Al, Zr, Ti (for example, Al₂O₃, ZrO₂, TiO₂ or the like). The main component of the cover layer 50 may be the main component of the solid electrolyte layer 30.

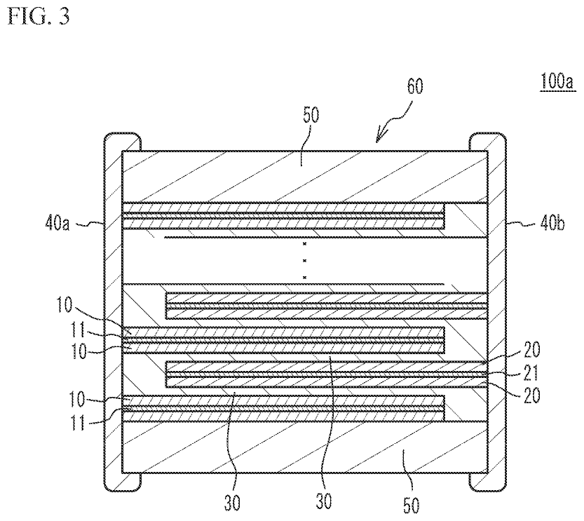

The first internal electrode 10 and the second internal electrode 20 may have an electric collector layer. For example, as illustrated in FIG. 3 a first electric collector layer 11 may be provided in the first internal electrode 10. A second electric collector layer 21 may be provided in the second internal electrode 20. A main component of the first electric collector layer 11 and the second electric collector layer 21 is a conductive material. For example, the conductive material of the first electric collector layer 11 and the second electric collector layer 21 may be such as a metal, carbon or the like. When the first electric collector layer 11 is connected to the first external electrode 40a and the second electric collector layer 21 is connected to the second external electrode 40b, current collecting efficiency is improved.

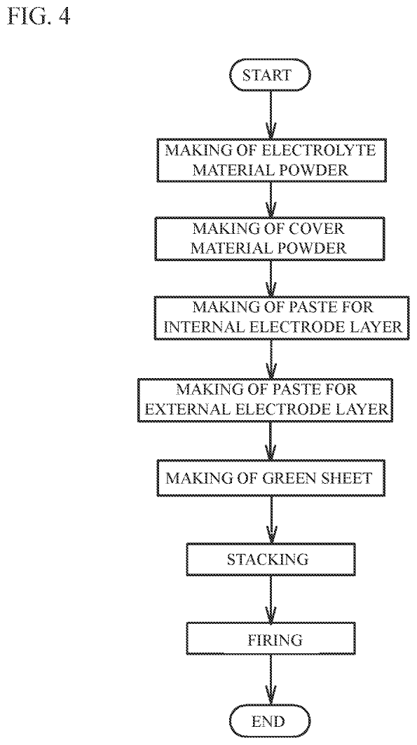

A description will be given of a manufacturing method of the all solid battery 100a illustrated in FIG. 2. FIG. 4 illustrates a flowchart of the manufacturing method of the all solid battery 100a.

(Making process of raw material powder for solid electrolyte layer) First, raw material powder for the solid electrolyte layer that constitutes the solid electrolyte layer 30 described above is prepared. For example, by mixing raw materials, additives and so on and using a solid-phase synthesis method or the like, a raw material powder of an oxide-based solid electrolyte can be made. By dry pulverizing the obtained raw material powder, it is possible to adjust to a desired average particle size. For example, a planetary ball mill using ZrO₂ balls of 5 mm ϕ is used to adjust the desired average particle size.

(Making process of raw material powder for cover layer) First, a ceramics raw material powder that constitutes the cover layer 50 described above is prepared. For example, raw material powder for the cover layer can be made by mixing raw materials, additives and so on and using a solid-phase synthesis method or the like. By dry pulverizing the obtained raw material powder, it is possible to adjust to a desired average particle size. For example, a planetary ball mill using ZrO₂ balls of 5 mm ϕ is used to adjust the desired average particle size.

(Making process for internal electrode) Next, an internal electrode paste for forming the above-described first internal electrode 10 and the second internal electrode 20 is made. For example, an internal electrode paste can be obtained by uniformly dispersing a conductive aid, an electrode active material, a solid electrolyte material, a sintering aid, a binder, a plasticizer, and so on in water or an organic solvent. As the solid electrolyte material, the solid electrolyte paste described above may be used. A carbon material or the like is used as the conductive aid. A metal may be used as the conductive aid. Examples of the metal of the conductive aid include Pd, Ni, Cu, Fe, and alloys containing these. Pd, Ni, Cu, Fe, alloys containing these, and various carbon materials may also be used. When the compositions of the first internal electrode 10 and the second internal electrode 20 are different from each other, the respective internal electrode pastes may be prepared separately.

As the sintering aid, for example, any glass component such as Li—B—O based compounds, Li—Si—O based compounds, Li—C—O based compounds, Li—S—O based compounds, and Li—P—O based compounds can be used.

(External electrode paste preparation process) Next, an external electrode paste for forming the first external electrode 40a and the second external electrode 40b is made. For example, an external electrode paste can be obtained by uniformly dispersing a conductive material, a glass frit, a binder, a plasticizer, and the like in water or an organic solvent.

(Forming process of green sheet) A solid electrolyte slurry having a desired average particle size is prepared by uniformly dispersing the raw material powder for the solid electrolyte layer in an aqueous solvent or an organic solvent together with a binder, a dispersant, a plasticizer, and so on followed by wet pulverization. At this time, a bead mill, a wet jet mill, various kneaders, a high-pressure homogenizer, or the like can be used. And it is preferable to use a bead mill from the viewpoint of being able to simultaneously adjust the particle size distribution and disperse. A binder is added to the obtained solid electrolyte slurry to obtain a solid electrolyte paste. By applying the obtained solid electrolyte paste, the solid electrolyte green sheet 51 can be formed. The applying method is not particularly limited. A slot die method, a reverse coating method, a gravure coating method, a bar coating method, a doctor blade method, or the like can be used. The particle size distribution after wet pulverization can be measured, for example, using a laser diffraction measurement device using a laser diffraction scattering method.

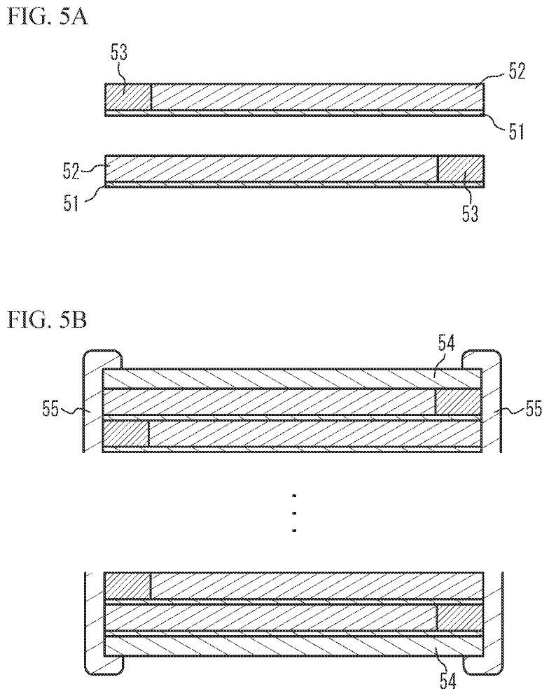

(Stacking process) Paste 52 for internal electrode is printed on one face of the solid electrolyte green sheet 51, as illustrated in FIG. 5A. A reverse pattern 53 is printed on a part of the solid electrolyte green sheet 51 where the paste 52 for electrode layer is not printed. A material of the reverse pattern 53 may be the same as that of the solid electrolyte green sheet 51. The solid electrolyte green sheets 51 after printing are stacked so that each of the solid electrolyte green sheets 51 is alternately shifted to each other. As illustrated in FIG. 5B, cover sheets 54 are crimped from an upper side and a lower side of the stacking direction. Thus, a multilayer structure is obtained. In this case, in the multilayer structure, the internal electrode paste 52 for the first internal electrode 10 is exposed on one end face, and the internal electrode paste 52 for the second internal electrode 20 is exposed on the other end face. The multilayer structure having a substantially rectangular parallelepiped shape is obtained. The cover sheet 54 is formed by printing the material powder for cover layer with the same method as the forming of the solid electrolyte green sheet. The thickness of the cover sheet 54 is larger than the thickness of the solid electrolyte green sheet 51. The cover sheet 54 may be thickened during printing of the cover sheet 54. The cover sheet 54 may be thickened by stacking the plurality of the printed sheets.

Next, the two end faces are coated with paste 55 for external electrode by dipping method or the like. After that, the paste 55 for external electrode is dried. Thus, a compact for forming the all solid battery 100a is obtained.

(Firing process) Next, the obtained multilayer structure is fired. The firing conditions are oxidizing atmosphere or non-oxidizing atmosphere, and the maximum temperature is preferably 400° C. to 1000° C., more preferably 500° C. to 900° C., without any particular limitation. A step of holding below the maximum temperature in an oxidizing atmosphere may be provided to sufficiently remove the binder until the maximum temperature is reached. In order to reduce process costs, it is desirable to perform the firing at as low a temperature as possible. After firing, re-oxidation process may be performed. Through the above steps, the all solid battery 100a is produced.

The internal electrode paste, a current collector paste containing the conductive material, and the internal electrode paste may be sequentially stacked to form current collector layers in the first internal electrode 10 and the second internal electrode 20.

### EXAMPLES

All solid batteries were produced according to the embodiments, and their characteristics were investigated.

(Example 1) LiCoPO₄ was used as the positive electrode active material having an average operating potential of 4.5V vs. Li/Li⁺ or more. LAGP glass was used as the solid electrolyte. Co₃O₄ was used as the Co source added to the solid electrolyte. The positive electrode active material, conductive aid, solid electrolyte, and Co₃O₄ are weighed out in a mass ratio of 35:10:54.5:0.5, and mixed in a mortar while adding an appropriate amount of binder to prepare positive electrode granulated powder.

TiO₂ was used as the negative electrode active material having an average operating potential of 2V vs. Li/Li⁺ or less, and LAGP glass was used as the solid electrolyte. The negative electrode active material, conductive aid, and solid electrolyte were weighed so that the mass ratio was 35:10:55, and mixed in a mortar while adding an appropriate amount of binder to prepare negative electrode granulated powder.

A predetermined amount of LAGP glass was molded using a mold to produce a solid electrolyte layer with a thickness of 300 μm. Thereafter, predetermined amounts of positive electrode granulated powder and negative electrode granulated powder were placed on both sides of the solid electrolyte layer, and press molding was performed to produce a compact. The produced compact was fired at a predetermined temperature to produce an all solid battery. During the firing process, a Co-containing phosphate solid electrolyte was obtained at the positive electrode. In this Co-containing phosphate solid electrolyte, the Co/P molar ratio was 1.7 mol %.

When the manufactured all solid battery was subjected to AC resistance measurement at 1 KHz in an 80° C. constant temperature oven, the AC resistance was found to be 345Ω. Thereafter, a constant current charge/discharge test was performed for 100 cycles in the range of 1.5V to 3.5V at a current of 0.2 C. The initial charging/discharging efficiency was calculated from the initial charging current capacity and discharging current capacity, and was found to be 58%. Further, the capacity retention rate after 100 cycles was calculated from the discharge current capacity at the 100th cycle and the initial discharge current capacity, and was found to be 60%.

(Example 2) An all solid battery was produced in the same manner as in Example 1, except that the positive electrode granulated powder had a mass ratio of positive electrode active material, conductive aid, solid electrolyte, and Co3O₄ of 35:10:54:1. In the Co-containing phosphate solid electrolyte of the positive electrode, the Co/P molar ratio was 3.3 mol %.

When the manufactured all solid battery was subjected to AC resistance measurement at 1 KHz in an 80° C. constant temperature oven, the AC resistance was found to be 340Ω. Thereafter, a constant current charge/discharge test was performed for 100 cycles at a current of 0.2 C. The initial charging/discharging efficiency was calculated from the initial charging current capacity and discharging current capacity, and was found to be 62%. Further, the capacity retention rate after 100 cycles was calculated from the discharge current capacity at the 100th cycle and the initial discharge current capacity, and was found to be 75%.

(Example 3) An all solid battery was produced in the same manner as in Example 1, except that the positive electrode granulated powder had a mass ratio of positive electrode active material, conductive aid, solid electrolyte, and Co₃O₄ of 35:10:53:2. In the Co-containing phosphate solid electrolyte of the positive electrode, the Co/P molar ratio was 6.7 mol %.

When the manufactured all solid battery was subjected to AC resistance measurement at 1 KHz in an 80° C. constant temperature oven, the AC resistance was found to be 321Ω. Thereafter, a constant current charge/discharge test was performed for 100 cycles at a current of 0.2 C. The initial charging/discharging efficiency was calculated from the initial charging current capacity and discharging current capacity, and was found to be 65%. Further, when the capacity retention rate after 100 cycles was calculated from the discharge current capacity at the 100th cycle and the initial discharge current capacity, the capacity retention rate was 83%.

(Example 4) An all solid battery was produced in the same manner as in Example 1, except that the positive electrode granulated powder had a mass ratio of positive electrode active material, conductive aid, solid electrolyte, and Co₃O₄ of 35:10:52:3. In the Co-containing phosphate solid electrolyte of the positive electrode, the Co/P molar ratio was 10.2 mol %.

When the manufactured all solid battery was subjected to AC resistance measurement at 1 KHz in an 80° C. constant temperature oven, the AC resistance measurement was found to be 310Ω. Thereafter, a constant current charge/discharge test was performed for 100 cycles at a current of 0.2 C. The initial charging/discharging efficiency was calculated from the initial charging current capacity and discharging current capacity, and was found to be 67%. Further, the capacity retention rate after 100 cycles was calculated from the discharge current capacity at the 100th cycle and the initial discharge current capacity, and was found to be 81%.

(Example 5) An all solid battery was produced in the same manner as in Example 1, except that the positive electrode granulated powder had a mass ratio of positive electrode active material, conductive aid, solid electrolyte, and Co₃O₄ of 35:10:51:4. In the Co-containing phosphate solid electrolyte of the positive electrode, the Co/P molar ratio was 13.5 mol %.

When the manufactured all solid battery was subjected to AC resistance measurement at 1 KHz in an 80° C. constant temperature oven, the AC resistance was found to be 33252. Thereafter, a constant current charge/discharge test was performed for 100 cycles at a current of 0.2 C. The initial charging/discharging efficiency was calculated from the initial charging current capacity and discharging current capacity, and was found to be 69%. Further, the capacity retention rate after 100 cycles was calculated from the discharge current capacity at the 100th cycle and the initial discharge current capacity, and was found to be 80%.

(Example 6) An all solid battery was produced in the same manner as in Example 1, except that the positive electrode granulated powder had a mass ratio of positive electrode active material, conductive aid, solid electrolyte, and Co₃O₄ of 35:10:50:5. In the Co-containing phosphate solid electrolyte of the positive electrode, the Co/P molar ratio was 16.8 mol %.

When the manufactured all solid battery was subjected to AC resistance measurement at 1 KHz in an 80° C. constant temperature oven, the AC resistance was found to be 380Ω. Thereafter, a constant current charge/discharge test was performed for 100 cycles at a current of 0.2 C. The initial charging/discharging efficiency was calculated from the initial charging current capacity and discharging current capacity and was 69%. Further, the capacity retention rate after 100 cycles was calculated from the discharge current capacity at the 100th cycle and the initial discharge current capacity, and was found to be 75%.

(Example 7) An all solid battery was produced in the same manner as in Example 1, except that the positive electrode granulated powder had a mass ratio of positive electrode active material, conductive aid, solid electrolyte, and Co₃O₄ of 35:10:49:6. In the Co-containing phosphate solid electrolyte of the positive electrode, the Co/P molar ratio was 20 mol %.

When the manufactured all solid battery was subjected to AC resistance measurement at 1 KHz in an 80° C. constant temperature oven, the AC resistance was found to be 932Ω. Thereafter, a constant current charge/discharge test was performed for 100 cycles at a current of 0.2 C. The initial charging/discharging efficiency was calculated from the initial charging current capacity and discharging current capacity, and was found to be 68%. Further, the capacity retention rate after 100 cycles was calculated from the discharge current capacity at the 100th cycle and the initial discharge current capacity, and was found to be 73%.

(Comparative Example 1) An all solid battery was produced in the same manner as in Example 1, except that the positive electrode granulated powder had a mass ratio of positive electrode active material, conductive aid, and solid electrolyte of 35:10:55. Therefore, in Comparative Example 1, Co was not added to the phosphate solid electrolyte of the positive electrode.

When the manufactured all solid battery was subjected to AC resistance measurement at 1 KHz in an 80° C. constant temperature oven, the AC resistance was found to be 323Ω. Thereafter, a constant current charge/discharge test was performed for 100 cycles at a current of 0.2 C. The initial charging/discharging efficiency was calculated from the initial charging current capacity and discharging current capacity, and was found to be 50%. Further, the capacity retention rate after 100 cycles was calculated from the discharge current capacity at the 100th cycle and the initial discharge current capacity, and was found to be 52%.

(Comparative Example 2) An all solid battery was produced in the same manner as in Example 1 except that the positive electrode granulated powder had a mass ratio of the positive electrode active material, the conductive aid, the solid electrolyte, and Co₃O₄ of 35:10:53:2, and the negative electrode granulated powder had the mass ratio of the negative electrode active material, the conductive aid, the solid electrolyte, and Co₃O₄ of 35:10:54.5:0.5. Therefore, Co was also added to the solid electrolyte of the negative electrode. In the Co-containing phosphate solid electrolyte of the positive electrode, the Co/P molar ratio was 6.7 mol %.

When the manufactured all solid battery was subjected to AC resistance measurement at 1 KHz in an 80° C. constant temperature oven, the AC resistance was found to be 314Ω. Thereafter, a constant current charge/discharge test was performed for 100 cycles at a current of 0.2 C. The initial charging/discharging efficiency was calculated from the initial charging current capacity and discharging current capacity, and was found to be 30%. Further, the capacity retention rate after 100 cycles was calculated from the discharge current capacity at the 100th cycle and the initial discharge current capacity, and was found to be 5%.

The initial charge/discharge efficiency and cycle characteristics of Examples 1 to 7 and Comparative Examples 1 and 2 were discussed. If the initial charge/discharge efficiency exceeded 50%, the initial charge/discharge efficiency was judged as good. If the capacity retention rate was 60% or more, the cycle characteristics were judged as good. Both the initial charge/discharge efficiency and cycle characteristics were judged as good, it was judged as good “○”. When either the initial charge/discharge efficiency or the cycle characteristics was not judged as good, it was determined as bad “x”. The results are shown in Table 1.

TABLE 1

| | | | | CAPACITY | | |
|---|---|---|---|---|---|---|
| | | | | RETENTION | | |
| | POSITIVE | NEGATIVE | INITIAL | RATE | | |
| | ELECTRODE | ELECTRODE | CHARGE/ | AFTER | | |
| | ELECTROLYTE | ELECTROLYTE | DISCHARGE | 100 | | |
| | (Co/P) | (Co/P) | EFFICIENCY | CYCLES | | ESR |
| | mol % | mol % | (%) | (%) | JUDGE | (1 kHz) |
| COMPARATIVE | 0 | 0 | 50 | 52 | X | 323 |
| EXAMPLE 1 | | | | | | |
| EXAMPLE 1 | 1.7 | 0 | 58 | 60 | ◯ | 345 |
| EXAMPLE 2 | 3.3 | 0 | 62 | 75 | ◯ | 340 |
| EXAMPLE 3 | 6.7 | 0 | 65 | 83 | ◯ | 321 |
| EXAMPLE 4 | 10.2 | 0 | 67 | 81 | ◯ | 310 |
| EXAMPLE 5 | 13.5 | 0 | 69 | 80 | ◯ | 332 |
| EXAMPLE 6 | 16.8 | 0 | 69 | 75 | ◯ | 380 |
| EXAMPLE 7 | 20 | 0 | 68 | 73 | ◯ | 932 |
| COMPARATIVE | 6.7 | 1.7 | 30 | 5 | X | 314 |
| EXAMPLE 2 | | | | | | |

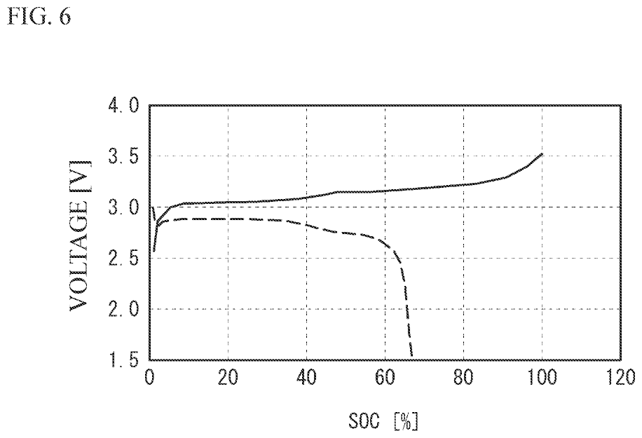

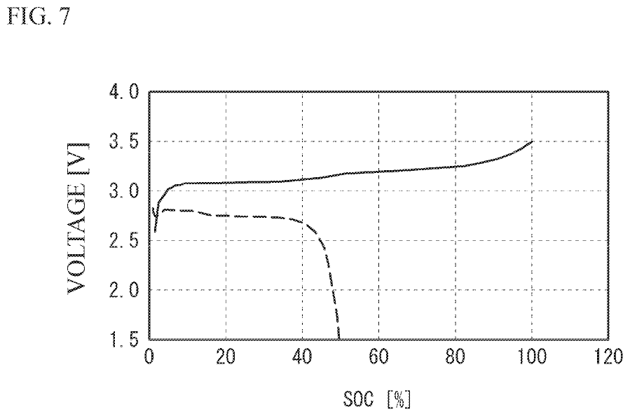

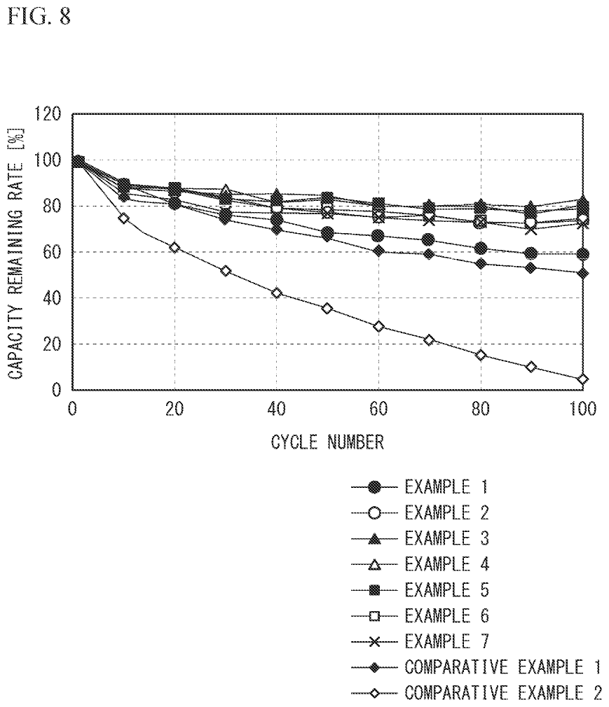

Note that FIG. 6 is a diagram showing the charge/discharge curve of Example 4. FIG. 7 is a diagram showing a charge/discharge curve of Comparative Example 1. The initial charge/discharge efficiency can be calculated from the charge/discharge curve. FIG. 8 is a diagram showing cycle characteristics for Examples 1 to 7 and Comparative Examples 1 and 2. In FIG. 8, the horizontal axis shows the number of cycles, and the vertical axis shows the capacity remaining rate.

As shown in Table 1, Comparative Example 1 was not judged as good in both initial charge/discharge efficiency and cycle characteristics. This is considered to be because the oxidation resistance of the positive electrode was reduced because a Co-containing phosphate solid electrolyte was not used as the solid electrolyte of the positive electrode. Comparative Example 2 was not judged as good in both initial charge/discharge efficiency and cycle characteristics. This is considered to be because the reduction resistance of the negative electrode was reduced because a solid electrolyte containing Co was used as the solid electrolyte of the negative electrode.

On the other hand, Examples 1 to 7 passed both initial charge/discharge efficiency and cycle characteristics. This is because the oxidation resistance of the positive electrode was improved by using a Co-containing phosphate solid electrolyte as the solid electrolyte of the positive electrode, and the reduction resistance of the negative electrode was improved by using a solid electrolyte that does not contain Co as the solid electrolyte of the negative electrode.

Note that the ESR of Example 7 was larger that of Examples 1 to 6. This is considered to be because the Co content in the Co-containing phosphate solid electrolyte contained in the positive electrode was large. From this result, it can be seen that from the viewpoint of ESR suppression, it is preferable that the Co/P molar ratio be 16.8 mol % or less in the Co-containing phosphate solid electrolyte contained in the positive electrode.

In any case of Examples 1 to 7, even if the positive electrode granulated powder does not use a solid electrolyte and Co₃O₄ but uses a phosphate-based solid electrolyte to which Co element has been added in advance, the results of Examples 1 to 7 can be achieved. Further, in Examples 1 to 7, the evaluation was performed using opposed batteries, but similar effects can be obtained with the stacked batteries according to the embodiments.

Although the embodiments of the present invention have been described in detail, it is to be understood that the various change, substitutions, and alterations could be made hereto without departing from the spirit and scope of the invention.

1. An all solid battery by comprising:
a solid electrolyte layer of a phosphate-based material having a NASICON structure;
a positive electrode layer that includes a Co-containing phosphate-based positive electrode active material and a Co-containing phosphate-based solid electrolyte; and
a negative electrode layer that includes a negative electrode active material and a solid electrolyte not containing Co.

2. The all solid battery as claimed in claim 1, wherein the all solid battery operates at an operating voltage of 2.5 V or more.

3. The all solid battery as claimed in claim 2, wherein:
the positive electrode active material operates at an average operating voltage of 4.5V vs. Li/Li⁺ or more; and
the negative electrode active material operates at an average operating voltage of 2.0 V vs. Li/Li⁺ or less.

4. The all solid battery as claimed in claim 1, wherein the Co-containing phosphate-based solid electrolyte of the positive electrode layer includes a glass ceramics in which a Co-containing solid electrolyte glass is crystallized.

5. The all solid battery as claimed in claim 1, wherein a molar ratio of Co/P is 16.8 mol % or less in the Co-containing phosphate-based solid electrolyte of the positive electrode layer.

6. The all solid battery as claimed in claim 1, wherein an average grain diameter of the Co-containing phosphate-based solid electrolyte of the positive electrode layer and an average grain diameter of the solid electrolyte not containing Co of the negative electrode layer are 0.1 μm or more and 10 μm or less.

7. The all solid battery as claimed claim 1, wherein a volume ratio of the Co-containing phosphate-based solid electrolyte of the positive electrode layer and a volume ratio of the solid electrolyte not containing Co of the negative electrode layer are 20 vol. % or more and 75 vol. % or less.
